(19) United States
(12) Patent Application Publication
(10) Pub. No.: US 2003/0127458 A1
(43) Pub. Date: Jul. 10, 2003

(54) Cover for stepped thermostat case

(76) Inventors: Steve Dushane, Granada Hills, CA (US); Kenneth Anderson, Simi Valley, CA (US); Richard Jung, Burbank, CA (US); John Staples, Burbank, CA (US)

Correspondence Address: David T. Bracken, The Law Office of David T. Bracken, 4839 Bond Aenue, Orange, CA, 92869, US

(21) Appl. No.: 10/039,561

(22) Filed: Jan. 8, 2002

(51) Int. Cl. B65D 55/14; H02G 3/14

(52) U.S. Cl. 220/241; 220/210

(57) ABSTRACT

The present invention is a thermostat cover, preferably lockable and at least releaseably latchable, such that the vented base part of the thermostat case is substantially free of the cover and allowing free air flow through the vents. The invention uses at least two overhangs formed between the base and upper parts of the thermostat case as engaging ends for the cover.

### BACKGROUND OF THE INVENTION

The present invention relates to cases and covers for thermostat cases with a lateral topmost part of its case wider than a wall connecting and base part of its case.

The prior art for housings or cases for many present day thermostats includes a stepped structure as to a part of the case next to the wall extending to a part of the case with an effectively greater horizontal and/or vertical outside measurement so that an overhang is formed as to either the upper and lower edges of the case or as to the left and right edges of the case.

U.S. Pat. No. 5,810,193 describes one type of cover for a thermostat. A sconce for mounting on a wall and concealing a thermostat provided on the wall to prevent viewing and undesired manipulation of the thermostat. The sconce has a sconce bracket which is mounted on the wall above the thermostat and includes a generally semicircular bracket panel which extends perpendicularly from the wall, parallel to the floor. A quarter globe-shaped sconce panel is removably mounted on the sconce bracket and abuts the wall below the sconce bracket to enclose and conceal the thermostat. The sconce bracket and bracket panel are each provided with multiple air vents for allowing ambient air to enter the sconce and contact the concealed thermostat. A decorative object such as a flower arrangement may be supported and displayed on the bracket panel.

U.S. Pat. No. 4,683,734 proposes a type of cover more representative of the currently most popular product. A locked cover for surrounding an air condition responsive controller such as a thermostat to prevent the setting from being altered by people unauthorized to do so. Baffles are opposite the openings in the cover to prevent tools from being inserted through these openings to adjust the control. The baffles have openings through them to permit air to flow to the controller. In one form, the baffles are rigidly secured in position in an otherwise existing type of guard cover. In another form of the invention, there are a plurality of interlocking pieces which can be fitted together and placed within an existing cover to prevent access to the adjustment for the controller. In still another version, the guard cover is modified so that the openings for admission of air are not adjacent the controller, but are spaced outwardly therefrom with the openings through the baffles adjacent the controller.

U.S. Pat. No. 4,584,856 is not a cover for a thermostat. It describes no critical venting required for covers of a thermostat cover. A security cover lockably engageable with surface mounted apparatus for preventing unauthorized access to the apparatus. The security cover includes a shell with peripheral sides which closely conform to the size of the apparatus over which it fits, and a pair of tangs on the shell edge wedgable between the apparatus and the surface. A key lock is mounted within the outer surface of the protective cover and includes a slotted finger rotatable with the lock cylinder. The fastener with which the apparatus is fixed to the surface is replaced by a double-headed fastener and is engageable with the slotted finger to thereby lock the protective cover to the apparatus. In the alternative, another apparatus screw is replaced with a double-headed fastener and, instead of tangs, a side edge of the cover is slotted for engagement with the second double-headed screw.

U.S. Pat. No. 3,734,335 shows a locking cabinet that used a lip interlocked under a metal flange where the distal side of a covering piece of the cabinet is secured with a screw.

The prior art thus describes covers for thermostats that enclose substantially the entire case and thus have to deal with the problem of vented flow of air into and out of the cover. The barrier to air flow necessarily makes the thermostat less responsive to actual temperature changes in the room. The present construction of thermostat cases, especially for digital and programmable thermostats, typically is of a wall-mount or base part of the case that is vented at the floor and ceiling facing walls. The case then extends peripherally to at least a horizontally wider case part, forming an overhang as to the wall on which it is mounted.

### SUMMARY OF THE INVENTION

The present invention is a thermostat cover, preferably lockable and at least releaseably latchable, such that the vented base part of the thermostat case is substantially free of the cover and allowing free air flow through the vents. The invention uses at least two overhangs formed between the base and upper parts of the thermostat case as engaging ends for the cover. Two additional walls run between the engaging ends to prevent removal of the cover from the thermostat. It has been found that the secure covering of the thermostat with the invention provides for openings or windows of different sizes to provide access to all, some or none of thermostat controls. The invention cover forms a frame or complete cover for the front and sides of the upper case of the thermostat without substantially affecting the critical air flow through the base part of the case.

### BRIEF DESCRIPTION OF THE DRAWINGS

FIGS. 1 and 2 are front views of digital thermostats of the Honeywell Corporation with door portions closed, where only some controls are accessible by the user.

FIGS. 3 and 4 are front views of digital thermostats of the Honeywell Corporation with door portions opened and permitting access to another set of thermostat controls.

FIGS. 5 and 6 are front views of digital thermostats of the White-Rodgers Corporation with door portions closed, where only some controls are accessible by the user.

FIGS. 7 and 8 are thermostats of the Carrier Corporation with respectively the door portion closed and open.

FIG. 9 is a generalized floorward or ceiling-ward view of a stepped case thermostat mounted on a wall with a wall mount or base part extending to an upper part, the base part having vents for air flow to a temperature sensor.

FIG. 10 is a horizontal side view of the thermostat of FIG. 9, showing that the stepped case may optionally extend toward the ceiling and floor.

FIG. 11 is a front view of the thermostat of FIG. 7 with the invention cover engaged to its surface as a frame around a display screen and some accessible controls.

FIG. 12 is a back perspective view of the invention cover.

FIGS. 13 and 14 are respectively back and front views of the invention cover without the locking mechanism.

FIG. 15 is cross section AA of FIG. 13 with the locking mechanism included.

FIG. 16 is the device of FIG. 15 with the thermostat of FIG. 9 securely engaged within the cover.

### DETAILED DESCRIPTION OF THE INVENTION

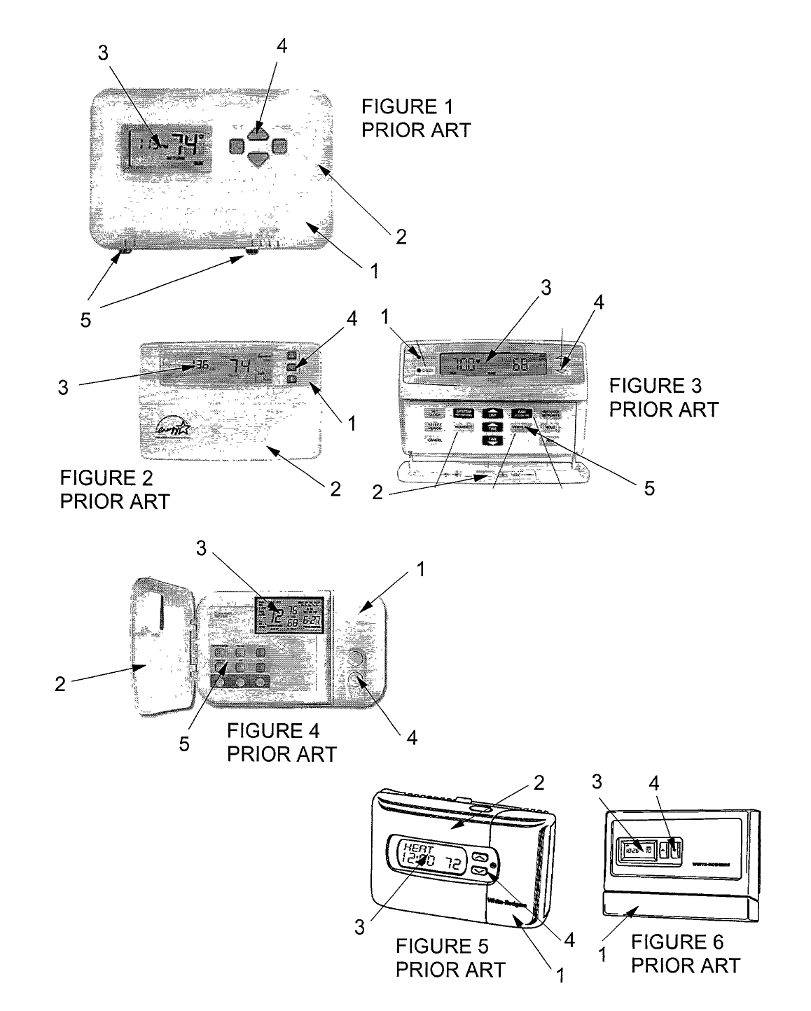

The invention is a cover adapted to work with a wide range of present day stepped case thermostats. The thermostats of FIGS. 1-10 are examples of the several forms that these thermostats take. Those thermostats generally share, although in various locations and with somewhat different structures, an upper case 1 having a door 2, a display 3, user controls 4 not covered by door 2, user controls 5 covered by door 2, and sometimes lower edge user controls 5A. In some thermostats, such as in FIGS. 1, 4, 5, 7 and 8, the door 2 has a window framing display 3 and sometimes controls 4, although the general purpose of door 2 is to hide controls 5 from view and reduce the likelihood of inadvertent change by pressing against them. Some thermostats, such as in FIGS. 2 and 3, do not frame the display 3 or controls 4 with a window in the door 2. The present invention is adapted to provide effective protection, preferably lockable protection, with the following options: prevention of door 2 opening to limit change of the thermostat settings with controls 5 and/or 5A: prevention of access to controls 4 to limit change of the thermostat settings; and prevention of viewing of display 3 so that occupants without the need to know cannot be aware of thermostat settings. Most importantly, the thermostats of FIGS. 1-8 have stepped cases as defined above.

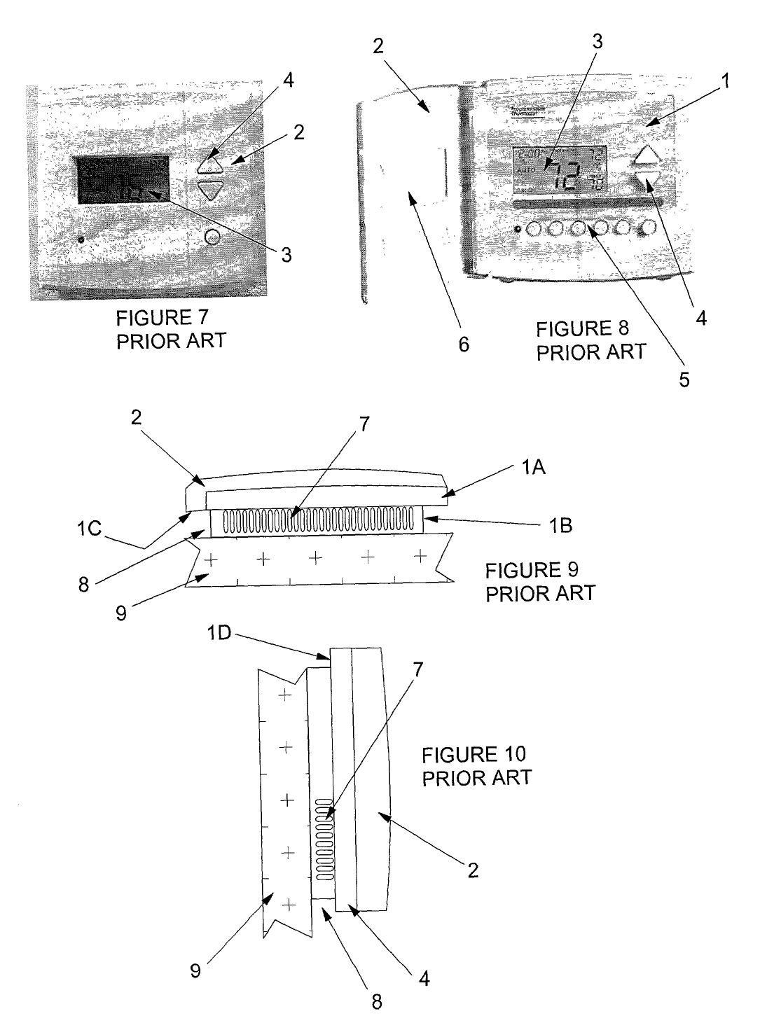

FIGS. 9 and 10 show several general features of the stepped case thermostat. Similar to the thermostat of FIGS. 7 and 8, FIG. 9 shows a door 2 overlaying an upper case 1A which is supported and connected to a horizontally shorter base case 1B, where case 1B has vents 7 for air flow across temperature sensing means within the case. The difference in widths of cases 1A and 1B results in overhang 1C defining area 8 (also on the other side of the FIG. 9 case). The two overhangs 1C for stepped thermostats are the ends engaged by the invention cover. One end will be engaged by its insertion in a receiving slot and the other end will be engaged by a latch and/or lock means. FIG. 10 shows a generalized side view of a wall 9 mounted stepped case thermostat. Optionally, although not required, case 1A in FIG. 10 extends to a greater vertical distance than case 1B, resulting in the visible overhang. The invention cover may be adapted to have a slot engaging one of such vertical overhangs.

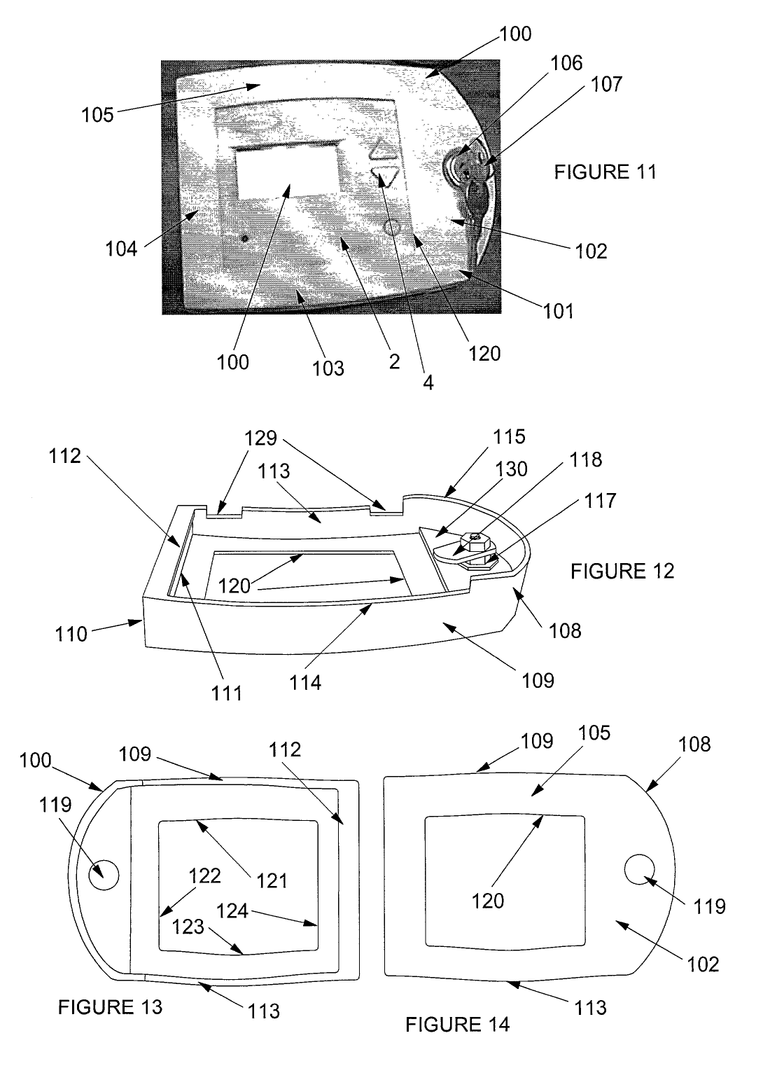

FIG. 11 shows the thermostat of FIG. 7 with the invention cover 100 locked over door 2, thereby giving access to the room occupant only to display 3 and controls 4. The window or frame 120 is defined by top 101 through its sections 102-105. Section 102 is provided with locking means including a rotatable lock 106 and keys 107. It is apparent from FIG. 11 that cover 100 is so closely pressed to door 2 that an unauthorized room occupant could not gain access to aspects or controls of the thermostat without removal of cover 100 from the thermostat.

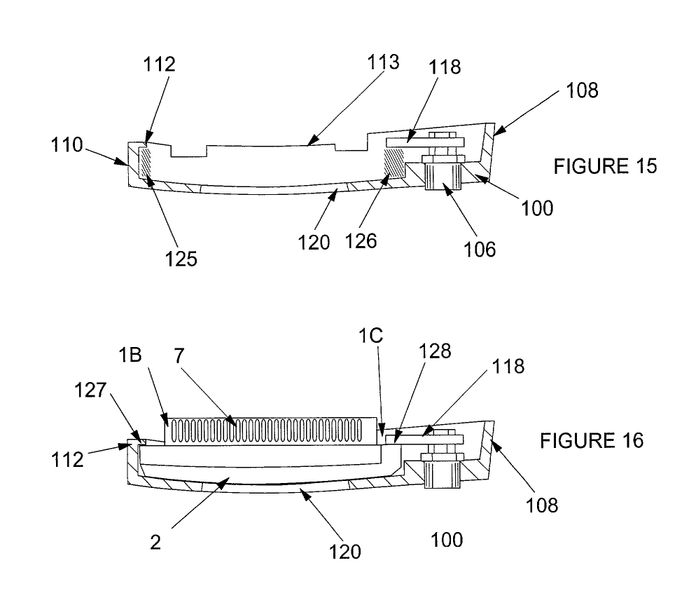

FIG. 12 shows a perspective view of the backside of cover 100, where it is seen that walls 108, 109, 110 and 113 extend downward from the outside edges of top 102. Slot 111 is formed from extension 112 at the bottom edge of wall 110, parts of walls 109 and 113, part of section 104 and wall 110. This slot is the engaging slot for receiving one of the two horizontal (or vertical if the cover is rotated 90 degrees) overhangs and securing it within a zone 125 as shown in FIG. 15. FIG. 12 shows that a preferable embodiment of the cover 100 uses a height 114 of walls 109, 110, and 113 less than height 115 of wall 108 at the end of the cover 100 with the locking means. The difference in height permits greater protection for interference with the locking means by an unauthorized user, i.e., since one of the objects of the invention is to provide relatively free air flow through the base 1B, wall 108 extends to a position close to the wall (when locked in position as in FIG. 16) in a way that is distal to that desired air flow. The height 115 of wall 108 will therefor not prevent substantially the same air flow through the stepped case thermostat before installation of the cover 100 as before.

Lock 106, as shown in FIG. 12 and extending through hole 119 as in FIGS. 13 and 14, includes lock nuts 117 and rotatable flange 118 which can be rotated into and out of contact with overhand 1C for locking the invention cover into position. A raised section 130 is optionally provided for locating the locking means latch structure (in this case flange 118) so that the latching or locking action brings the inside surfaces of sides 102-105 into relatively close association to the front surface of a stepped case thermostat.

FIG. 12 shows notches 129 which can be optionally provided to allow access for controls 5A as in FIG. 1. The present invention provides a wealth of options in the form of frame sizing. Frame 120 comprises edges 121-124 in FIG. 13. It is within skill in the art with the present disclosure to substantially change the size and shape of frame 120 to adapt it to provide access to none, one or many of the several features of the stepped case thermostats of FIGS. 1-8. For instance, the display 3 of FIG. 1 may be restricted only to allow visual or manipulative access to the ambient air temperature, only the set temperature or only the controls 4. Although the present invention cover will work to prevent opening of door 2 on all the stepped case thermostats, the cover of the invention will work equally effectively if the stepped case thermostat has no door at all. The desired access to visual or manipulative features of the stepped case thermostat can be accommodated with the invention cover also with multiple frames or providing that all or part of the invention cover is formed with a clear polymer. A small, unlocked door may be hinge attached to near one of edges 121-124 to cover frame 120 for aesthetic purposes, thereby providing security for the desired features and a decorative or plain overall visual effect.

FIG. 15 shows zones 125 and 126. As shown in FIG. 16 and in applying the invention cover to a stepped case thermostat, the backside of cover 100 is presented toward the front face of the thermostat and one overhang 1C is moved into slot 111 to occupy zone 125. In a hinged-like manner, end of cover 100 with wall 108 is pressed toward the distal overhang 1C to the one engaged in slot 111. This action brings the inside surface of sections 102-105 into association and some contact with the front face of the stepped case thermostat. The key 107 is rotated causing flange 118 to slide beneath the distal overhang 1C to form interface 128, while the slot 111 engagement of the overhang results in interface 127.

FIG. 16 shows a generalized stepped case thermostat with the invention cover locked in place with vents 7 substantially vertically free of interference by walls 113 and 114. This means that the critical vertical (and to a lesser extent horizontal) air flow up to down through the base part vents is substantially unhindered by installation of the invention cover. No prior art device has demonstrated such security for visual and/or control features of stepped case thermostats in this way. Disclosure of the thermostats of FIGS. 1-8 is made so that it may be appreciated that the specific shape of the invention cover can be adapted to the particular stepped case features of any of those thermostats, i.e., the thermostat of FIG. 1 would have an invention cover somewhat horizontally longer than that for the thermostat of FIG. 7. The specific example in the FIGS. 11-16 is most particularly suited to the thermostat of FIG. 7, although such particularity is not a limitation on the scope of the present invention as to a broad application to stepped case thermostats.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

We claim:

1. A cover adapted to be latched or locked to a stepped case thermostat, the stepped case thermostat comprising a base part of the case adapted to be mounted to a wall, where the base part extends to an upper part of the case that has a mounted horizontal width greater than that of the base part and resulting in two first overhangs in the mounted position, the improvement comprising:
(a) a substantially planar flat or curved top cover surface extending to peripheral edges from which side walls extend from the top surface to a height adapted to substantially cover the upper part of the case in an installed position;
(b) a slot formed by a first side wall, adjacent parts of two adjacent side walls and a ledge extending from a free edge of the first side wall, such that the slot is adapted to securely receive one of the first overhangs in the slot; and
(c) latching or locking means extending from the back side of the top surface at sufficient distance and location from the first side wall that such that installation of the cover causes the slot to securely receive one of the first overhangs, the inside surface of the top surface is brought close to a front face of the thermostat, and a surface of the latching or locking means engages the second of the first overhangs to keep the cover in place.

2. The cover of claim 1 wherein a window is formed in the top surface.

3. The cover of claim 2 wherein the window is adapted to permit visual and manipulative access only to a display on the thermostat when the cover is in the installed position.

4. The cover of claim 2 wherein the window is adapted to permit visual and manipulative access only to a display on the thermostat and fewer than all the user controls on the thermostat when the cover is in the installed position.

5. The cover of claim 2 wherein the window is adapted to permit visual and manipulative access only to a display on the thermostat and to the user controls on the thermostat adapted to change temperature setpoints when the cover is in the installed position when the cover is in the installed position.

6. The cover of claim 1 wherein the cover is adapted to permit opening of a door on the front face of the thermostat only when the cover is removed from the thermostat.

7. The cover of claim 1 wherein the heights of the side walls adjacent to the first side wall are limited such that in an installed position they do not substantially interfere with vertical flow of air through a vented base part of the case.

8. The cover of claim 1 wherein one of the side walls adjacent to the first side wall has one or more notches adapted to permit operation of user controls on the thermostat when the cover is in an installed position on the thermostat.

9. The cover of claim 1 wherein the inside surfaces of the top surface and side walls are adapted to cover a substantially square thermostat.

10. The cover of claim 1 wherein the inside surfaces of the top surface and side walls are adapted to cover a substantially rectangular thermostat.

11. The cover of claim 1 wherein the inside surfaces of the top surface and side walls are adapted to cover a substantially oval or round thermostat.

12. A cover for a thermostat, the thermostat comprising a case with a base part, where the base part extends to an upper part that has a mounted horizontal width greater than that of the base part and resulting in two first overhangs in the mounted position, the improvement comprising:
(a) a top cover surface extending to peripheral edges from which side walls extend from the top surface to a height adapted to substantially cover the upper part when installed;
(b) slot means adapted to securely receive one of the first overhangs in the slot;
and
(c) latching or locking means extending from the back side of the top surface at sufficient distance and location from the first side wall that such that installation of the cover causes the slot to securely receive one of the first overhangs, the inside surface of the top surface is brought close to a front face of the thermostat, and a surface of the latching or locking means engages the second of the first overhangs to keep the cover in place.

13. The cover of claim 12 wherein a window is formed in the top surface.

14. The cover of claim 13 wherein the window is adapted to permit visual and manipulative access only to a display on the thermostat when the cover is in the installed position.

15. The cover of claim 13 wherein the window is adapted to permit visual and manipulative access only to a display on the thermostat and fewer than all the user controls on the thermostat when the cover is in the installed position.
